(19) United States
(12) Patent Application Publication
(10) Pub. No.: US 2007/0115686 A1
(43) Pub. Date: May 24, 2007

(54) Lighting assembly, backlight assembly, display panel, and methods of temperature control

(76) Inventor: Luc Tyberghien, Ooigem (BE)

Correspondence Address: HARTMAN PATENTS PLLC, 3399 FLINT HILL PL., WOODBRIDGE, VA, 22192, US

(21) Appl. No.: 11/285,380

(22) Filed: Nov. 23, 2005

(51) Int. Cl. F21V 29/00; F21V 7/20; G02F 1/1335

(52) U.S. Cl. 362/580; 362/218; 362/294; 362/561; 362/613

(57) ABSTRACT

Embodiments include lighting assemblies having light sources (for example, fluorescent lamps) that are at least partially embedded in a thermally conductive and optically transmissive medium. A reflecting surface is disposed at a side of the medium opposite the light sources, and a backplate is thermally coupled to the medium. Other embodiments include a display panel having such a lighting assembly and methods of controlling a temperature of such an assembly.

### FIELD OF THE INVENTION

This invention relates to lighting panels and display panels.

### BACKGROUND

For flat-panel display applications, it may be desired to obtain a lighting assembly that provides a substantially uniform distribution across a plane. For example, such an assembly may be used for backside illumination of a transmissive or transreflective display panel such as a liquid crystal display (LCD).

An LCD device generally includes a glass LCD panel and a backlight system. The display may also include circuitry such as lamp driver electronics, panel driver electronics, and an interface card to convert an analog or digital video signal (such as digital video interface or DVI) into another form such as low-voltage differential signaling (LVDS). Typical advantages of LCD technology over cathode-ray tube (CRT) technology include a smaller size and less weight for a similar display area.

Backlight systems include edge-light type and direct type backlights. A direct-type backlight typically can provide a higher light intensity than an edge-light type, and thus a direct-type backlight is typically more suitable for large-sized display panels.

Operating environments for LCD displays may be limited in temperature due to the nature of the LCD technology. Above a particular temperature, the LCD molecules become randomly oriented, rather than being aligned according to the applied voltage. At high temperatures, an LCD display may become opaque, yielding a black display regardless of the driving signal. This phenomenon, called “clearing” of the panel, is temporary and nondestructive, but it limits use of the panel to within certain temperature limits. High temperatures may also cause reduced efficiency and lifetime of the light sources and/or circuitry.

### SUMMARY

A lighting assembly according to one embodiment includes a light source; a backplate having a reflecting surface arranged to reflect light of the light source; and a heat transfer substrate disposed between the light source and the reflecting surface and arranged to transfer heat between the light source and the backplate. The heat transfer substrate is substantially transparent to light of the light source and has a thermal conductivity greater than that of air. The heat transfer substrate includes an interface in contact with the light source, which interface is substantially transparent to light of the light source and has a thermal conductivity greater than that of air.

A lighting assembly according to another embodiment includes a plurality of light sources disposed in a substantially planar arrangement; a backplate having a reflecting surface arranged to reflect light of the plurality of light sources; and a heat transfer substrate disposed between the plurality of light sources and the reflecting surface and arranged to transfer heat between the plurality of light sources and the backplate. The heat transfer substrate is generally planar, is substantially transparent to light of the plurality of light sources, and has a thermal conductivity greater than that of air. The heat transfer substrate includes a plurality of interfaces, the plurality of interfaces being substantially transparent to light of said light sources and having thermal conductivities greater than that of air. Each of the plurality of interfaces is in contact with a corresponding one of the plurality of light sources.

Embodiments also include methods of controlling a temperature of a lighting assembly, such as a lighting assembly according to one of the other embodiments. One such method includes receiving an indication of at least one of (A) a luminance of the light source and (B) a temperature of at least one among the light source, the backplate, and the heat transfer substrate; and controlling at least one among a cooling device and a heating device to change a temperature of the backplate. The act of controlling is based at least in part on the received indication.

### BRIEF DESCRIPTION OF THE DRAWINGS

FIGS. 1A-1C show cross-sections of representative portions of assemblies according to different embodiments.

FIGS. 2-7 show top views of assemblies according to different embodiments.

FIGS. 8A-8C show cross-sections of representative portions of assemblies according to different embodiments.

FIG. 9 shows a top view, two sectional views, and two side views of an assembly according to an embodiment.

FIGS. 10A and 10B show cross-sections of representative portion of assemblies according to different embodiments.

FIGS. 10C and 10D show cross-sections of implementations of backplate 400.

FIG. 11 shows a perspective representation of an assembly according to an embodiment.

FIG. 12 shows a perspective representation of an assembly including an embodiment as shown in FIG. 11 including a collector.

FIGS. 13A-13C show cross-sections of representative portion of assemblies according to different embodiments.

FIGS. 14A and 14B show cross-sections of representative portion of assemblies according to different embodiments.

FIG. 15 shows an example of a relation between luminance and temperature.

FIGS. 16A-18 show examples of sensor placements.

FIGS. 19-22 show examples of methods of temperature control according to different embodiments.

FIG. 23 shows a cross-section of an edge-lit backlight assembly according to an embodiment.

### DETAILED DESCRIPTION

Fluorescent tubes are an efficient and mature lighting technology. For high-brightness applications, fluorescent lamps are typically more economical than light-emitting diodes (LEDs). Fluorescent lamps are currently the technology of choice for backlight assemblies for LCD panels. An LCD panel typically transmits only seven percent of the illuminating light, however. A color LCD panel typically has lower light transmission than a monochrome panel, and it may be desirable to obtain a comparable brightness to a monochrome (grayscale) display. For example, it may be desired to achieve a display brightness of 500 cd/m². Such a display brightness requires a very bright backlight.

A direct-type backlight assembly includes one or more lamps within a box, with the LCD panel on one side of the lamps and a reflector on the other side of the lamps. Display brightness may be increased by increasing the light intensity of the backlight: for example, by including more lamps and/or raising the lamp driving current. However, such solutions may lead to increased heat generation. The efficiency of fluorescent lamps decreases at high temperatures, and high temperatures may also lead to clearing of the LCD panel. Internal ventilation of the backlight may not be feasible, as it may be desirable to keep out dust.

Embodiments include embedding lamps in a thermally conductive and optically transmissive medium for improved heat distribution, possible thermal control. The light source is at least partially embedded in a heat transfer element, which passively transfers heat between the lamps and a backplate. The backplate may be actively cooled (for example, forced-air cooling by a fan).

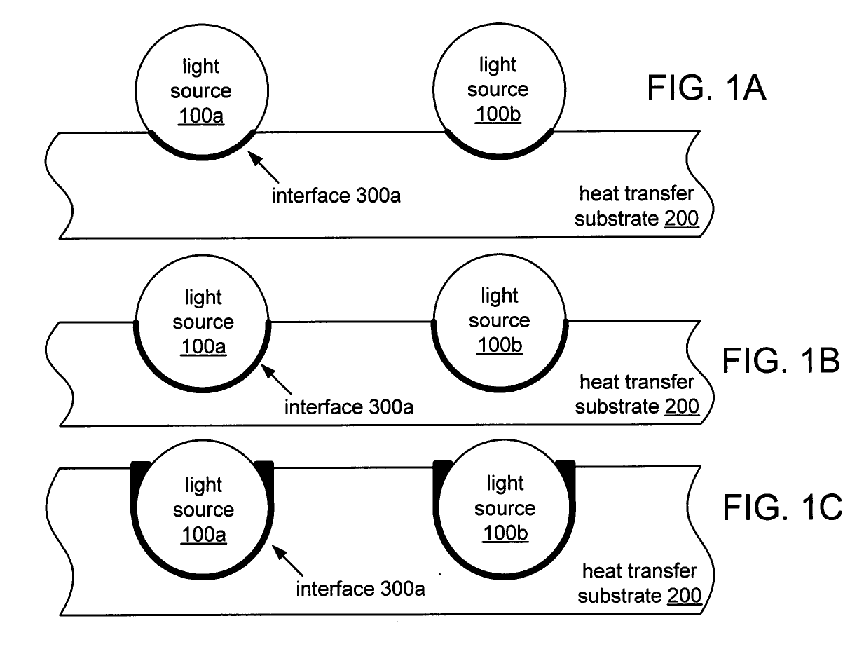

FIG. 1A shows a cross-section of light sources 100a,b partially embedded in a heat transfer substrate 200. Light sources 100a,b may be different light sources or different parts of the same source (e.g. a U-shaped lamp as described below). In other embodiments, the light source may have a different shape in cross-section, such as rectangular or elliptical, with the embedding being along either axis.

Light source 100 may be implemented as an elongated tube. In examples as described herein, light source 100 is a cold-cathode fluorescent lamp (CCFL). Such lamps are typically driven at a frequency of tens of kHz, typically 20-100 kHz, and a voltage of 900-1500 volts, and they may have an operating lifetime of 20,000 hours or more. The lamp holder is typically made of silicone rubber or plastic, and it may be desirable for the lamp holder to have a low dielectric constant to minimize losses (for example, the lamp holder may be porous). In other implementations, light source 100 may be a hot-cathode fluorescent lamp, an LED, or another lighting technology.

Heat transfer substrate 200 is a solid that has a thermal conductivity greater than air (i.e. greater than 0.025 W/(m·K)). Heat transfer substrate 200 is also substantially transparent or translucent to visible light (or to light of the light source 100 that is desired for the particular application). In the examples described herein, heat transfer substrate 200 is made of polymethyl methacrylate (PMMA), which has a thermal conductivity of 0.187 W/(m·K), about seven times greater than that of air. In other implementations, glass may be used (thermal conductivity of 1.1-1.2 W/(m·K)), although PMMA transmits more visible light (92% transmission) than glass. Especially in applications where light source 100 includes fluorescent lamps (or where the desired application includes ultraviolet illumination), it may be desirable for heat transfer substrate 200 to be resistant to clouding from exposure to ultraviolet radiation.

Heat transfer substrate 200 may have any dimensions desired for the particular application, although it may be desired to limit the thickness of the substrate to reduce absorption of light from the light source, to limit the quantity of heat stored in the substrate, and/or to increase the rate of heat transfer to a backplate. In the particular examples described herein, heat transfer substrate 200 is a sheet about four millimeters thick. It may also be desirable for heat transfer substrate 200 to be at least as large as an LCD panel to be illuminated.

Heat transfer substrate 200 is thermally coupled to light source 100 via an interface 300, which also has a thermal conductivity greater than air and is substantially transparent or translucent to visible light (or to light of the light source 100 that is desired for the particular application). For example, interface 300 may be optically clear. The thickness of interface 300 may be only a few tenths of a millimeter. In one example, light sources 100 are tubes of diameter 4.6 mm, embedded in channels of heat transfer substrate 200 that have diameter 5 mm, such that the intervening spaces along the lengths of the channels are filled by respective interfaces 300. It may also be desirable for interface 300 to have an index of refraction η similar to that of heat transfer substrate 200 and/or light source 100. Using materials having similar indices of refraction may help to reduce internal reflections at their interface. For PMMA, the index of refraction η=1.49, and it may be desirable for interface 300 to have an index of refraction not less than 1.39 and not greater than 1.59. In the examples as described herein, interface 300 is a layer of a silicone polymer.

In other implementations, heat transfer substrate 200 may be made of a soft, deformable, or nonrigid solid (such as a silicone polymer) having the specified thermal and optical properties. In such cases, the material of heat transfer substrate 200 may be capable of forming a good thermal and optical bond to light source 100, and interface 300 may be indistinguishably included in heat transfer substrate 200.

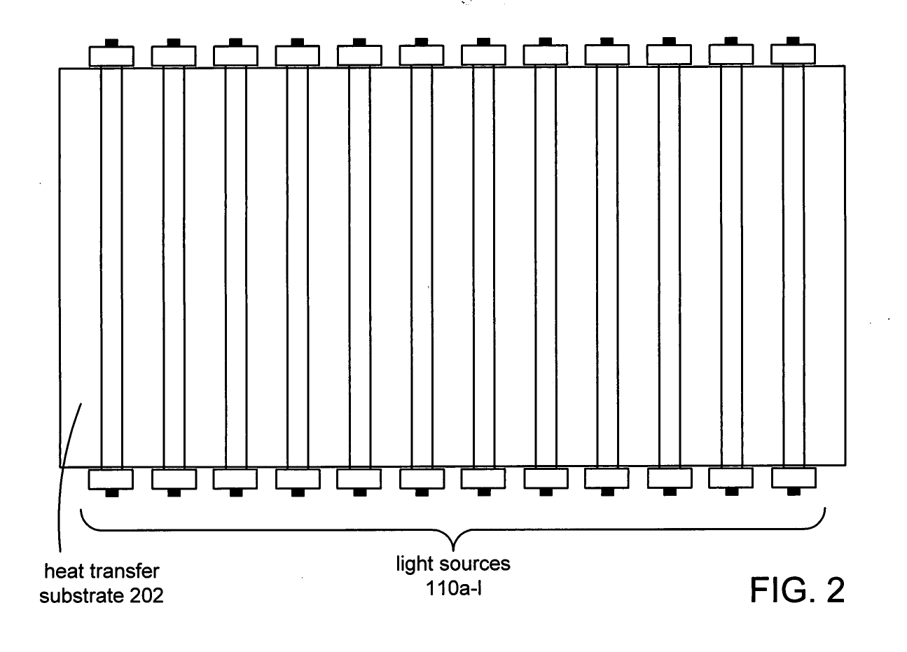

FIG. 2 shows a top view of an example of an assembly including implementations 110 of light source 100 (straight fluorescent tubes) and a suitably dimensioned implementation 202 of heat transfer substrate 200. In the examples described herein, light sources 100 produce white light, but in other implementations light sources of two or more different colors may be used.

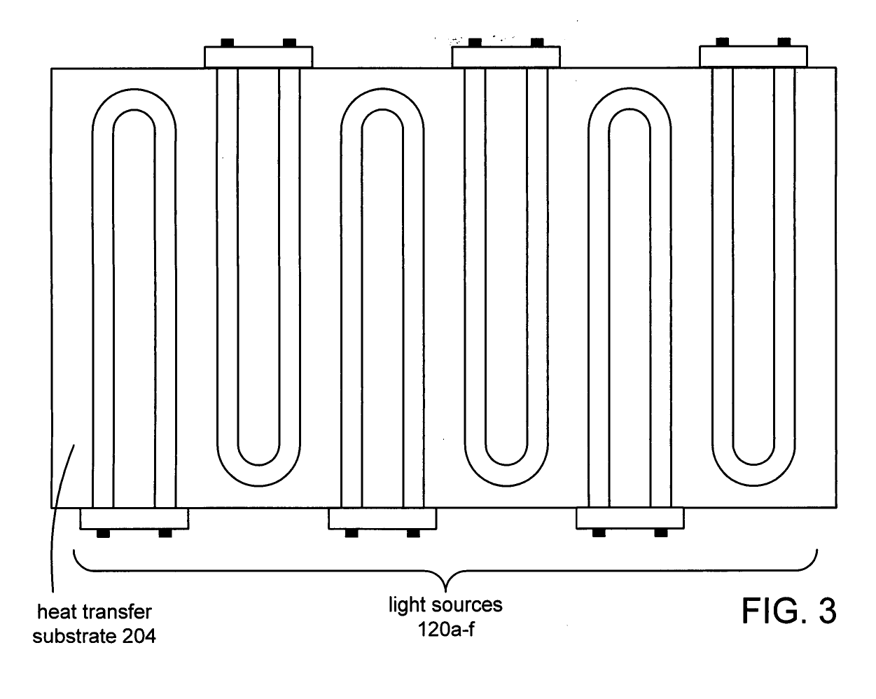

FIG. 3 shows a top view of an example of an assembly including implementations 120 of light source 100, which are U-shaped fluorescent tubes. A U-shaped fluorescent lamp is typically more efficient than a straight one. In one example, each lamp 120 is about 435 millimeters long, with a distance of 16.4 millimeters between the axes of the lamp legs, and a tube diameter of 4.6 millimeters. In one assembly, a planar arrangement of ten tubes is used, with the adjacent legs of each pair of tubes being the same distance apart as the legs of each tube. In other embodiments, light sources having other shapes (such as spiral, serpentine, or circular shape) may be used, and an assembly may include light sources having more than one shape and/or light sources of more than one technology (such as fluorescent tubes and LEDs).

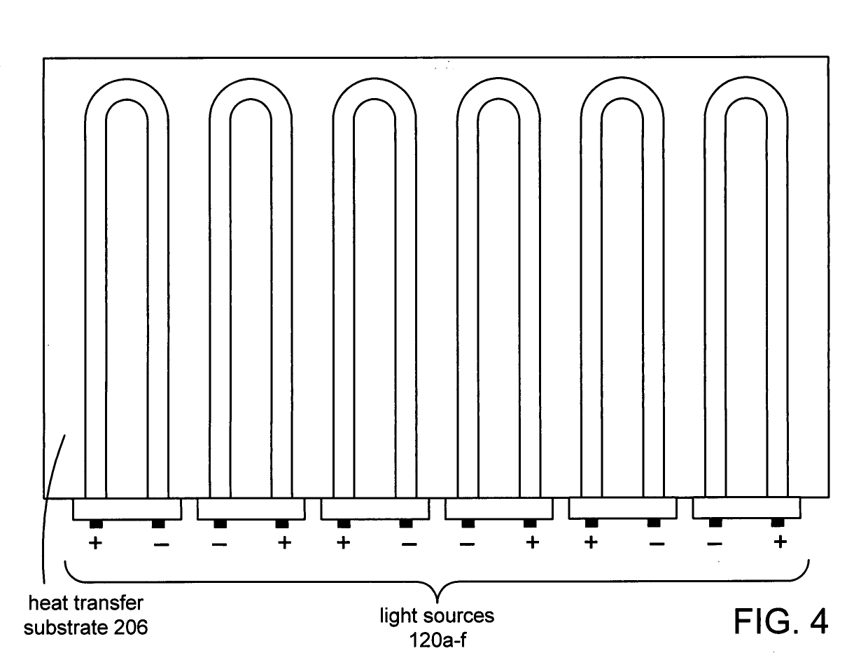

FIG. 4 shows another planar arrangement including U-shaped lamps 120, in which each tube is oriented in the same direction. It may be desirable to control the phase at which the lamps 120 are driven such that adjacent lamps are driven out-of-phase (for example, according to the polarities shown in FIG. 4) to minimize losses from high-voltage differences between the lamps.

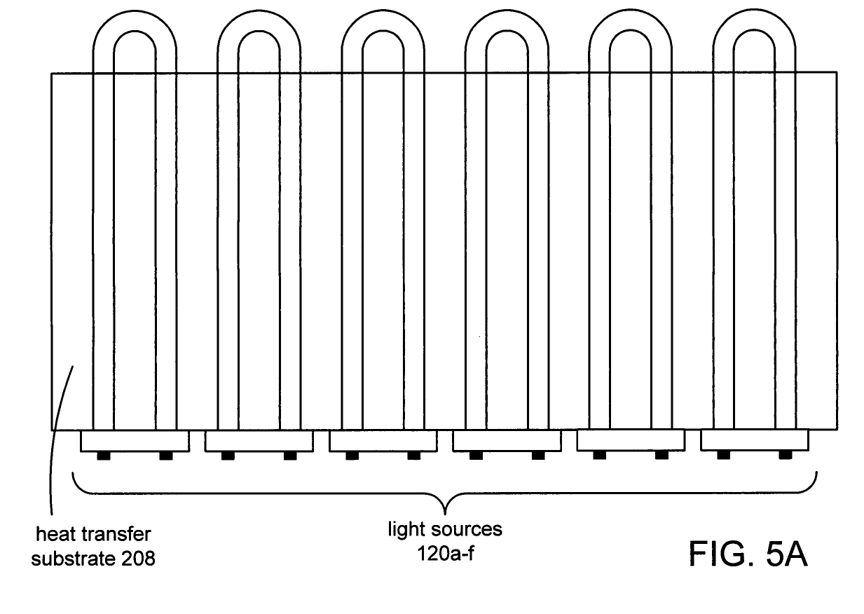

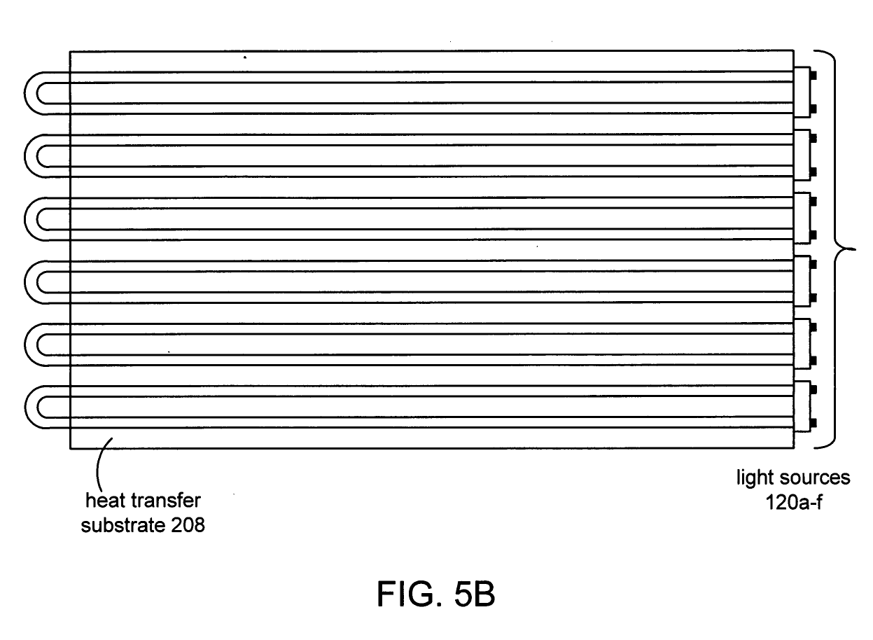

FIG. 5A shows another planar arrangement including an implementation 208 of heat transfer substrate 200 in which the curves of the lamps 120 extend beyond the edge of the substrate. Such an arrangement may provide better illumination uniformity over the area of heat transfer substrate 208 (and thus better illumination uniformity over the area of a matching display panel). Elongated light sources such as lamps 120 may be arrayed along a short dimension of a front surface of heat transfer substrate 200, as shown in FIGS. 2-5A, or along a long dimension of a front surface of heat transfer substrate 200, as shown in FIG. 5B.

Heat transfer substrate 200 may have undesirable electrical properties. For example, the dielectric constant of PMMA (ε is about 4 at 60 Hz) is about four times higher than that of air (ε=1). At the high voltages used to drive fluorescent lamps, this property may lead to increased electrical losses due to a reduced impedance to the high-frequency signal that powers the light sources. This parasitic capacitance may cause losses and lower lamp efficiency.

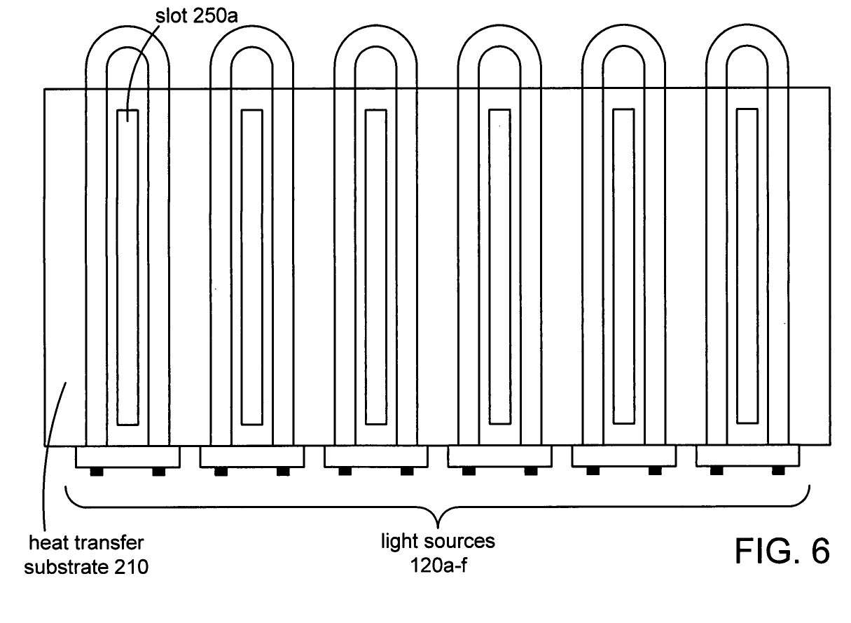

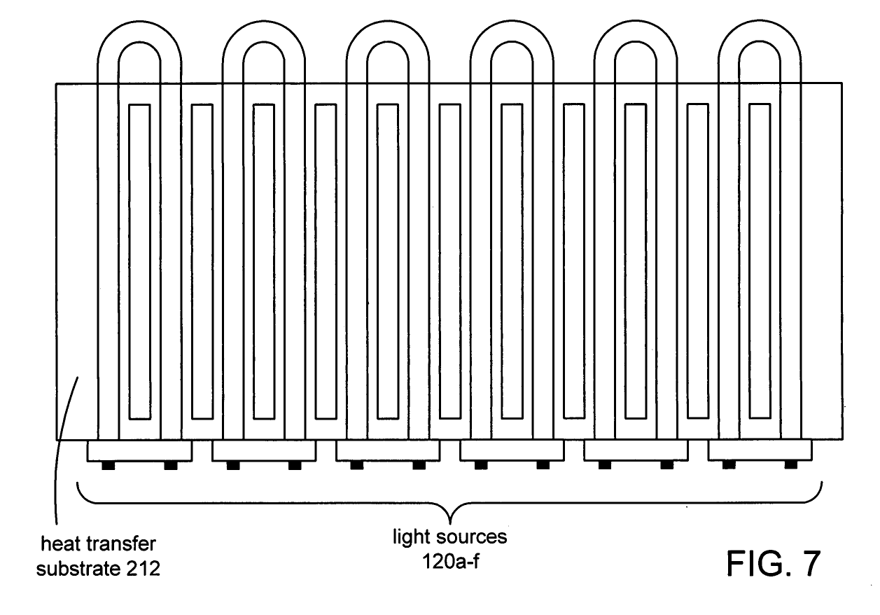

FIG. 6 shows an arrangement in which an implementation 210 of heat transfer substrate 200 includes slots 250 between the legs of each lamp 120. Slots 250 may help to reduce losses between lamp legs by reducing the dielectric constant in regions of high voltage. FIG. 7 shows another arrangement in which a similar implementation 212 of heat transfer substrate 200 includes slots between the legs of adjacent lamps 120. Such slots may not be needed if adjacent lamps may be driven out-of-phase as shown in FIG. 4, but they may be included nevertheless in case of phase drift between the driving currents of adjacent lamps. It is expressly noted that slots as shown in FIGS. 6 and/or 7 may also be used in any of the configurations shown in FIGS. 2-5B.

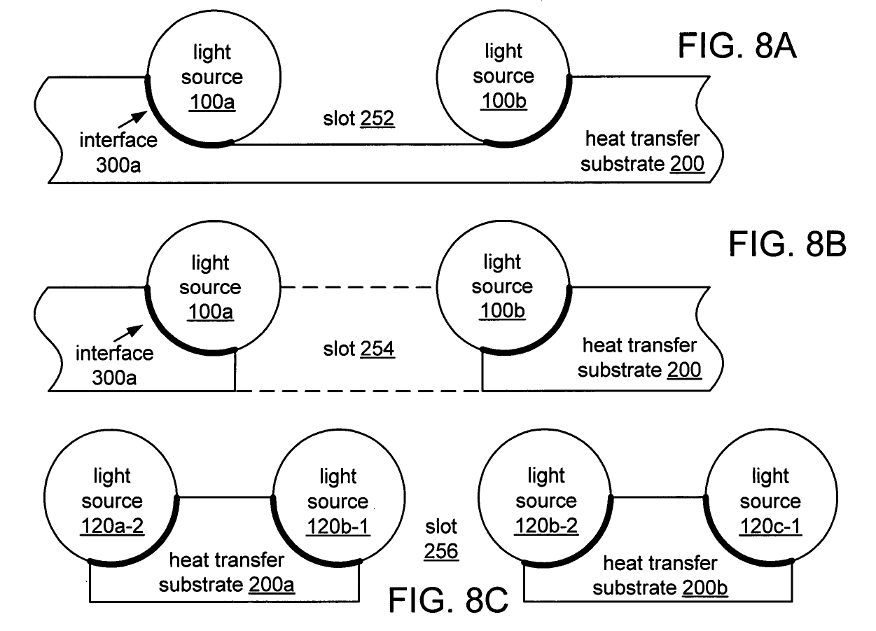

As shown in the cross-section of FIG. 8A, a slot 250 may be implemented as a depression 252 between light sources (or between legs of a light source). Alternatively, as shown in the cross-section of FIG. 8B, a slot 250 may be implemented as a hole or gap 254 in heat transfer substrate 200. In a further alternative as shown in the cross-section of FIG. 8C, heat transfer substrate 200 may be implemented as strips, such that a slot 250 is formed by a space 256 between adjacent strips. In this example, legs of adjacent lamps 120 are supported by a strip of the substrate, while legs 1,2 of the same lamp 120-b are separated by slot 256. Further implementations of heat transfer substrate 200 may include any combination of these three alternatives. For example, a slot 250 may be implemented as one or more depressions and/or holes of any desired shape, having sharp and/or rounded edges and corners. A particular shape of slot 250 may be selected based on factors such as cost of fabrication and manufacture, desired degree of electrical isolation, desired degree of optical continuity, and desired degree of structural rigidity of heat transfer substrate 200.

As described above, slots 250 may be implemented as air gaps. Alternatively, one or more of slots 250 may be filled with another substantially transparent material having a low dielectric constant. For example, polyethylene may be used (ε of about 2), or a silicone having suitable electrical and optical properties. Optically clear silicones having a dielectric constant less than three are currently available.

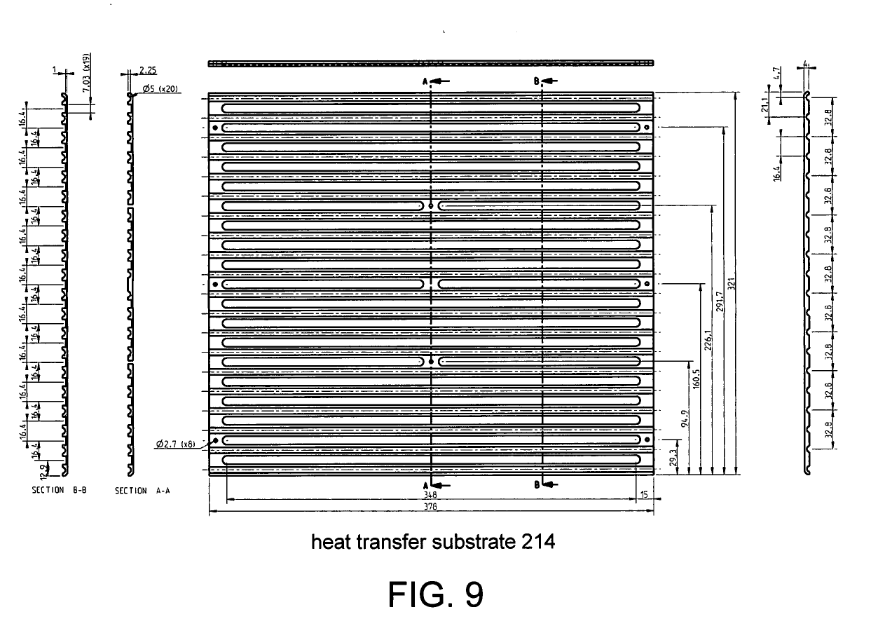

FIG. 9 shows several views of an implementation 214 of heat transfer substrate 200. Specifically, FIG. 9 includes a top view in the center, two cross-sections on the left, and edge views on the top and right side of the figure. In this example, heat transfer substrate 214 is a generally planar sheet measuring about 320 by 380 millimeters.

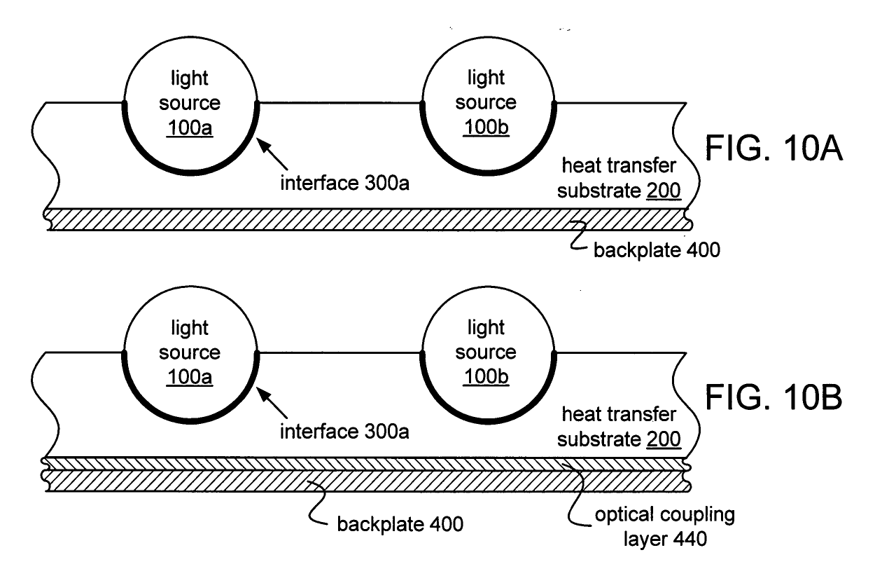

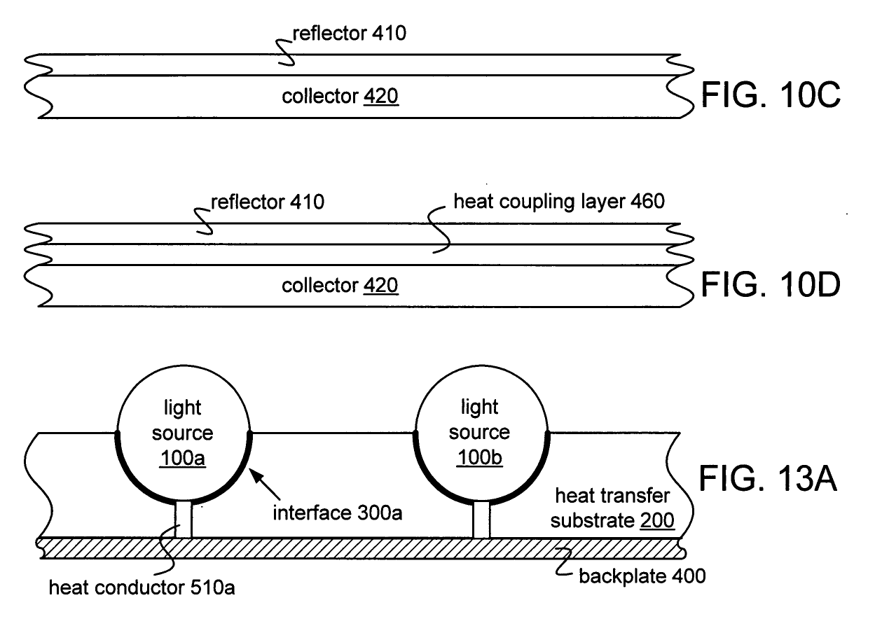

FIG. 10A shows a cross-section of an assembly including a backplate 400. Backplate 400 includes a reflecting surface disposed to reflect light back into heat transfer substrate 200. In examples as described herein, backplate 400 also functions as a heat sink. The reflecting surface of backplate 400 may be made of aluminum, silver, or any other metal or alloy that forms a highly reflective surface. The reflecting surface may be implemented as a foil, sheet, layer, or film and may have a specular finish.

In some cases, the reflecting surface is a layer or film that is deposited on the back surface of heat transfer substrate 200. In other implementations, the reflecting surface may be a high-reflectance diffusing or scattering surface, such as white powder, plastic, or paint, which in some cases may also be deposited on the back surface of heat transfer substrate 200. As shown in FIG. 10B, the reflecting surface may be optically coupled to heat transfer substrate 200 by an optical coupling layer 440. In an example as described herein, layer 440 is implemented as a transparent and thermally conductive film or sheet (such as silicone). Such coupling may reduce internal reflections at the surface of heat transfer substrate 200.

FIG. 10C shows a cross-section of an implementation 402 of backplate 400. Backplate 402 includes a reflector 410 (for example, a foil, sheet, layer, or film), having the reflecting surface as described above, and a collector 420. Reflector 410 may be directly mounted to collector 420 via fasteners (for example, screws or clips securing backplate 402 to heat transfer substrate 200). Alternatively, as shown in FIG. 10D, reflector 410 may be joined to collector 420 via a heat coupling layer 460 such as an adhesive (e.g. an epoxy) or thermally conductive paste. Examples of such a paste include suspensions of zinc oxide, aluminum oxide, aluminum nitride, and/or precipitated silver.

Collector 420 is made of a material of high thermal conductivity. Examples include a metal such as aluminum, copper, magnesium, titanium, silver, or stainless steel; an alloy including one or more such metals; or a polymer composite material. It may be desirable for collector 420 to have an appropriate thickness and/or mass to provide sufficient heat sinking capacity. A back side of collector 420 may have fins, or an otherwise increased surface area, for increased transfer of heat to the air. For example, collector 420 may include a substantially planar sheet that is thermally coupled to a finned heat sink. It may also be desirable for collector 420 to be cooled with forced air (e.g. by one or more fans). Collector 420 may also be cooled using one or more Peltier devices. In other implementations, collector 420 is cooled by a passive or forced liquid or gas, such as water, benzene or other cooling fluid or gas.

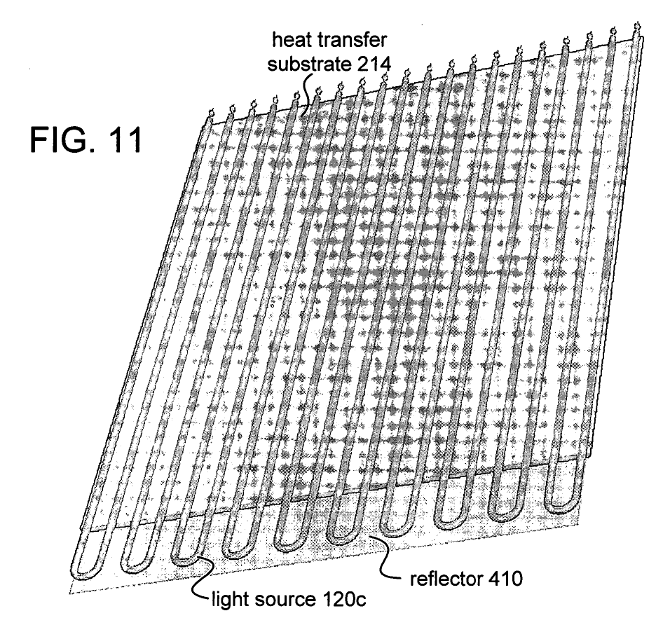

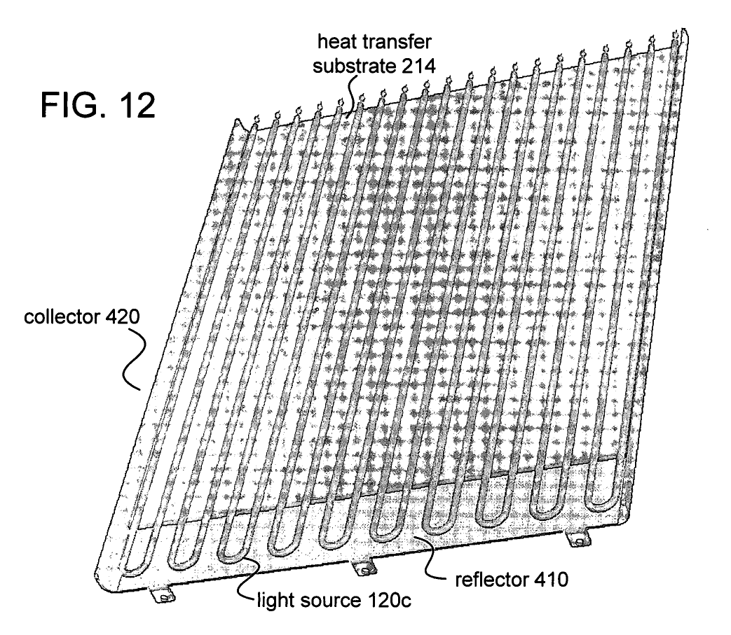

FIG. 11 shows a perspective view of an assembly including heat transfer substrate 214, ten light sources 120, and an implementation of reflector 410. FIG. 12 shows a perspective view of such an assembly including an implementation of collector 420.

It may be desired for backplate 420 to be electrically connected to a ground potential of the lighting assembly. In such case, it may also be desirable to drive the lamps between symmetrical voltages around the ground potential of backplate 420 (e.g. between −500 and +500 volts), instead of between the ground potential and a maximum potential (e.g. between 0 and +1000 volts). Such symmetrical driving may help to minimize leakage to ground (e.g. via a parasitic capacitance across heat transfer substrate 200).

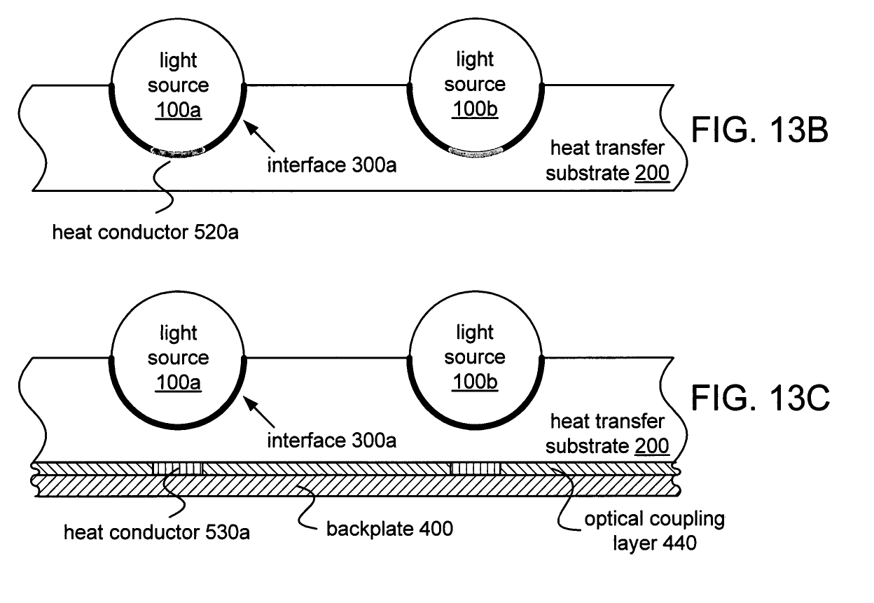

It may be desired to include additional elements having higher thermal conductivity, which may also be opaque, in a region at the back side of light source 100. FIG. 13A shows a cross-section of one such arrangement that includes one or more heat conductors 510 between a light source 100 and backplate 400. FIG. 13B shows a cross-section of an arrangement in which one or more heat conductors 520 take the place of a portion of the interface 300. FIG. 13C shows a cross-section of an arrangement in which one or more heat conductors 530 take the place of a portion of optical coupling layer 440. Heat conductors 510-530 may be implemented variously as, for example, spots or beads of thermally conductive paste or epoxy; or metal pieces, strips, or plugs. In the case of metal pieces, strips, or plugs, the heat conductors may be integrated with or fastened to backplate 400, passing through gaps in heat transfer substrate 200. The temperature distribution may not be homogeneous along the lamp, as typically the local lamp temperature decreases as distance from the electrodes increases. Therefore, it may be desirable to locate or concentrate such heat conductors 510-530 near the electrodes.

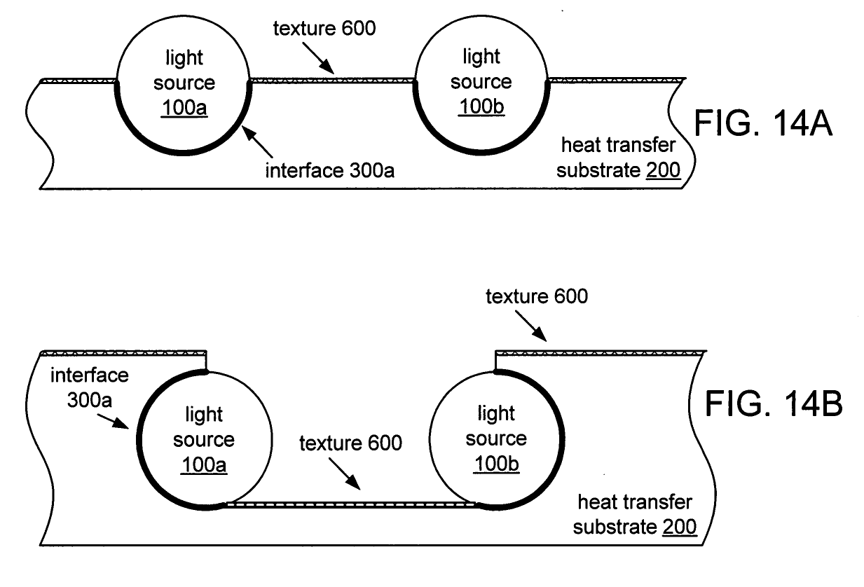

In a further embodiment, a microstructure or other texture is applied to the top surface of the heat transfer substrate. FIGS. 14A and 14B show cross-sections of two assemblies having such a texture on a top surface of heat transfer substrate 200. The microstructure may be applied or deposited on the surface. Alternatively, the microstructure may be created chemically (such as by etching the surface of substrate 200) and/or mechanically (such as by abrading and/or scoring the surface of substrate 200). The texture may have a regular pattern (such as a set of grooves in one or more directions) or may be irregular or random. Such a microstructure or texture may serve to diffuse light shining out of heat transfer substrate 200, to improve light transmission from substrate 200, and/or to reduce internal reflection within substrate 200.

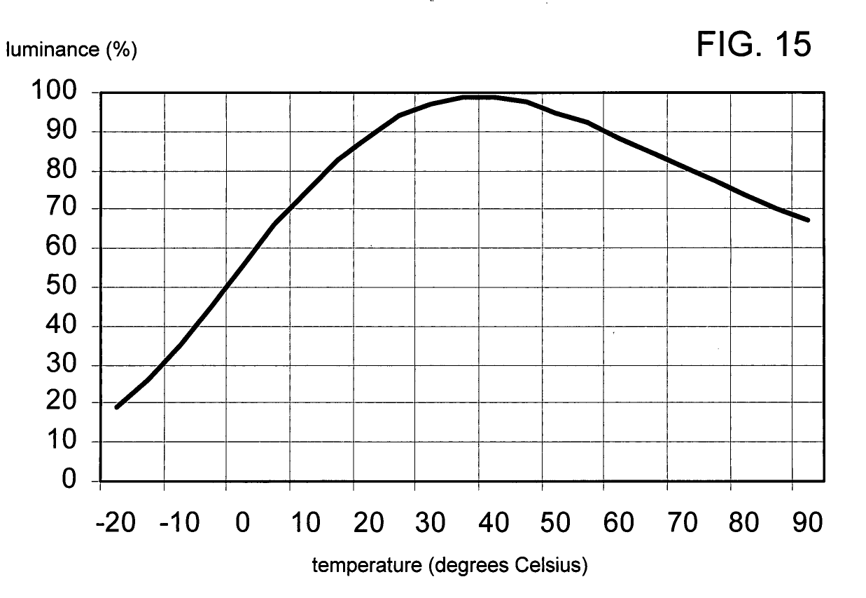

High operating temperatures adversely affect the luminous efficiency and operating lifetimes of fluorescent lamps. The same is also true of low operating temperatures, and for a constant driving current there exists a particular operating temperature or temperature range at which the lamp reaches an optimal efficiency and operating lifetime, typically between about 30 and 75 degrees Celsius. More specifically, an optimal operating temperature for a CCFL is typically about 40 degrees Celsius. FIG. 15 shows one example of a relation between luminance and lamp temperature for a constant driving current.

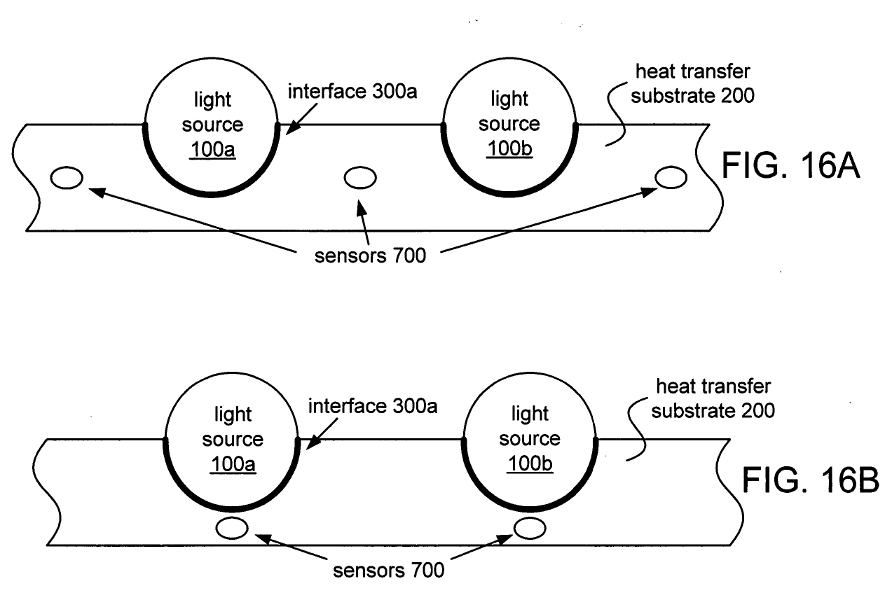

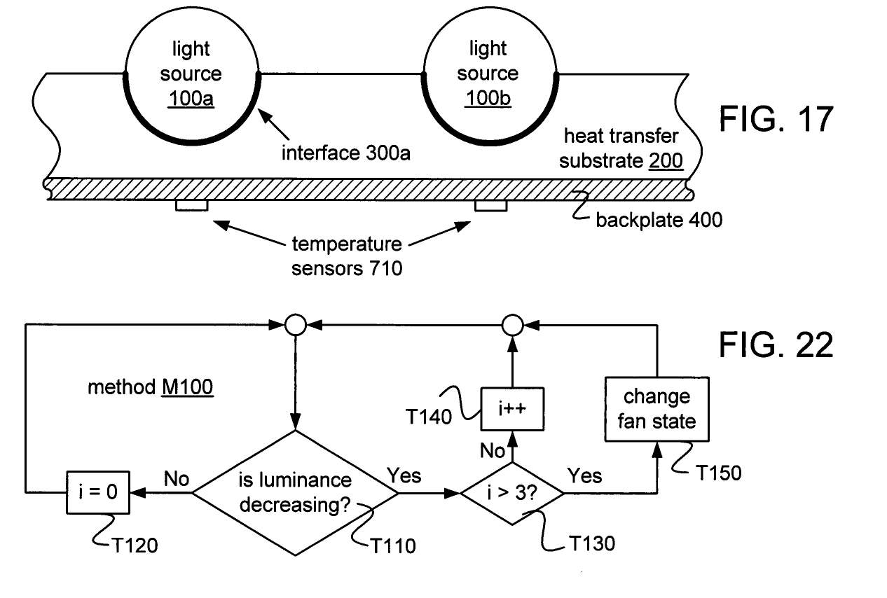

Thermal coupling of the light source to the backplate may also provide opportunities for improved temperature control of the light sources, and further embodiments include systems and methods of temperature control. Some methods include a characterization operation, which uses optical and temperature sensors to identify an optimal operating temperature (in other words, a temperature at which luminance output is maximum for a constant driving current). These sensors may be placed in any of various locations, and the temperature or luminance output may be taken as an average of the outputs of the individual sensors. For example, sensors 700 (temperature sensors 710 and/or light sensors 720) may be embedded or inserted into heat transfer substrate 200, between the light sources 100 (as shown in the cross-section of FIG. 16A) and/or behind the light sources 100 (as shown in the cross-section of FIG. 16B). As shown in the cross-section of FIG. 17, temperature sensors 710 may be located on the outer surface of backplate 400. Without limitation, temperature sensors 710 may be implemented using silicon devices or thermistors.

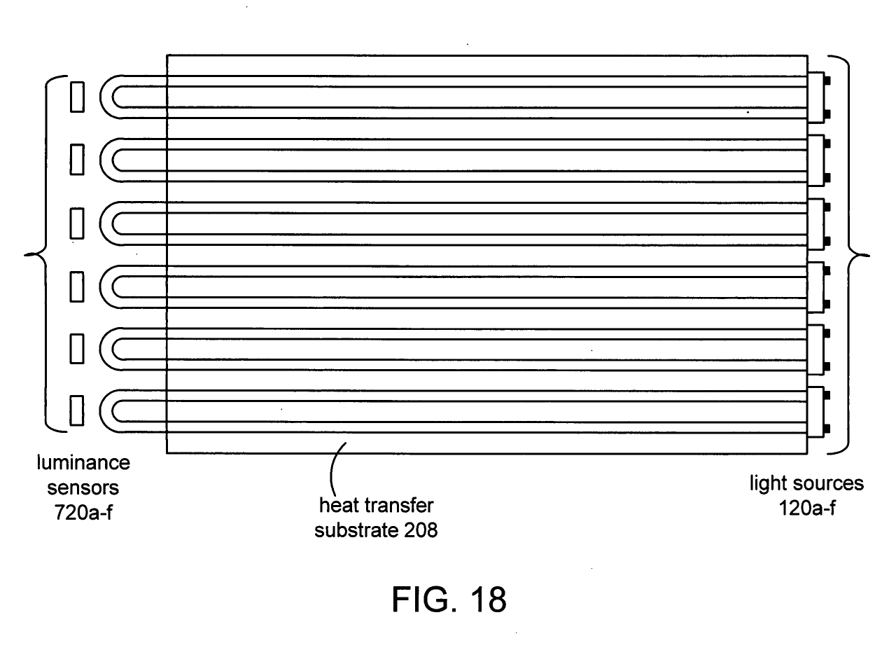

Light or temperature sensors may also be mounted, fixed, or otherwise positioned in other locations near to the light sources 100. For example, FIG. 18 shows a top view of an arrangement in which luminance sensors 720 are located to indicate the light output of each light source 120. Without limitation, luminance sensors 720 may be implemented using photovoltaic or photoresistive elements.

The optimal operating temperature as identified during the characterization operation (or, equivalently, a temperature sensor reading corresponding to that temperature) may be entered into a storage element of the assembly such as a nonvolatile memory or a DIP switch. Alternatively, the characterization operation may be omitted and a desired temperature may be selected according to other information, such as a known operating profile of the light source or a characterization of a similar assembly. During operation of the lighting assembly, a cooling device (such as one or more fans and/or Peltier devices) and/or a heating device (such as a resistive heater) is controlled to cool or heat backplate 420 to maintain the desired temperature.

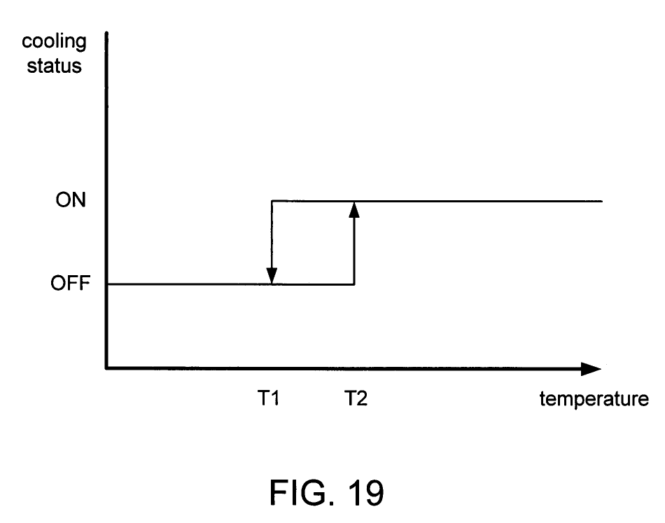

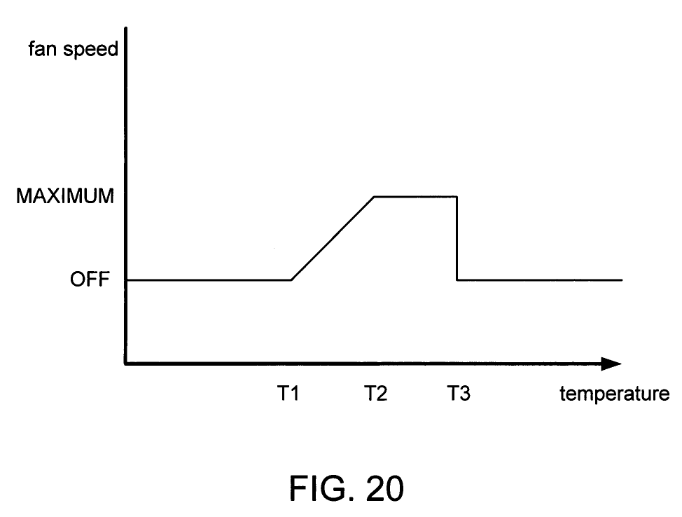

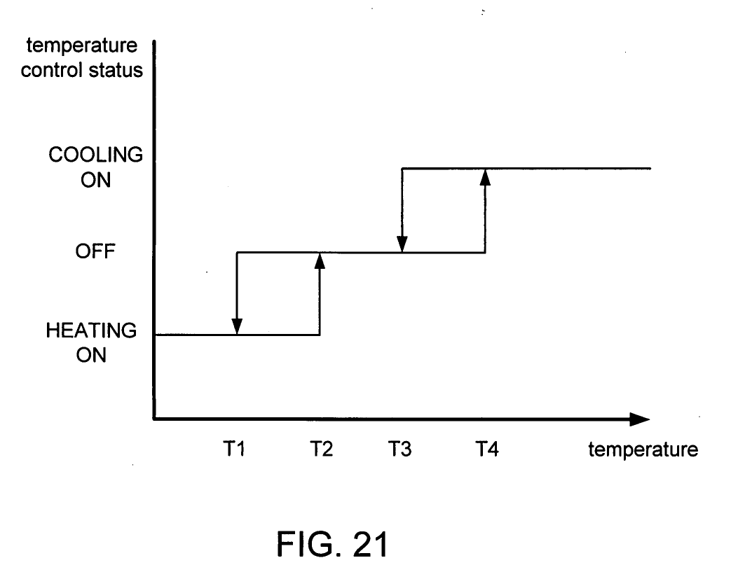

FIGS. 19-21 show examples of several different temperature control schemes. FIG. 19 shows an example of a scheme in which a cooling unit is activated when a temperature T2 is reached and deactivated when a lower temperature T1 is reached. The temperature points T1 and T2 may be selected to be slightly lower and higher, respectively, than the desired target temperature. FIG. 20 shows an example of a scheme in which a fan is off until a temperature T1 is reached. Temperature T1 may be selected to be near to the desired target temperature. Between temperatures T1 and T2, the speed of the fan is increased linearly according to the sensed temperature. At temperature T2, the fan speed is maximum. In this example, a thermal cutoff shuts down power to the assembly if a critical temperature T3 is reached. FIG. 21 shows an example of a scheme similar to that of FIG. 19 in which both heating and cooling are controlled. In this case, the desired target temperature may lie between temperature points T2 and T3.

In other methods, temperature control is performed according to sensed luminance output. FIG. 22 shows a flowchart of one example M100 of such a method. Task T110 determines whether luminance is currently decreasing. In one example, task T110 makes this decision based on the two most recent luminance measurements. If luminance is not decreasing, then task T120 resets a counter and task T100 repeats after some measurement interval. If task T110 determines that luminance is decreasing, task T130 tests the current value of the counter. If the counter value has not reached a threshold, task T140 increments the counter value, and task T110 repeats after some measurement interval. In this example, the threshold value is four. If task T130 determines that the counter value has reached the threshold, then task T150 changes the state of the cooling unit between activation and deactivation. The counter value may be selected based on an interval between luminance measurements (or an interval between repetition of task T110) and according to a desired hysteresis delay.

Sensing of the luminance output of each light source (for example, as in the configuration shown in FIG. 18) may also be used to obtain increased uniformity of illumination. In further systems and methods, the driving circuitry of the light sources is configured to control the individual light sources according to their luminance outputs (for example, by adjusting their individual driving currents) such that the light sources have equal luminance outputs. Such a method may be used in conjunction with a method of temperature control by luminance monitoring, such as the method shown in FIG. 22.

Methods of temperature and/or luminance control as described herein may be performed by a control unit including one or more heating devices and/or cooling devices as described herein. A control unit may also include one or more arrays of logic elements (for example, a microprocessor or embedded processor) executing one or more routines in firmware and/or software. Embodiments also include data storage media (for example, semiconductor memory, optical disks, or magnetic disks) having one or more sets of machine-executable instructions for performing operations of a method as disclosed herein.

A display panel may include a lighting assembly, according to one or more of the implementations disclosed herein, being used as a backlight for an LCD or other imaging panel. Such a panel may have a resolution of 1280×1024, or 1600×1200 pixels, or more (for example, 2560×1600, 2560×1920, or 3480×2400 pixels). The LCD panel may be transmissive or transreflective, and may be a monochrome or color LCD. Suitable technologies include active matrix (AM), thin-film transistor (TFT), and super twist nematic (STN). A lighting assembly according to one or more of the implementations disclosed herein may also be used as a backlight to an imaging panel according to another LCD technology or some other light valve, transmissive, or transreflective technology.

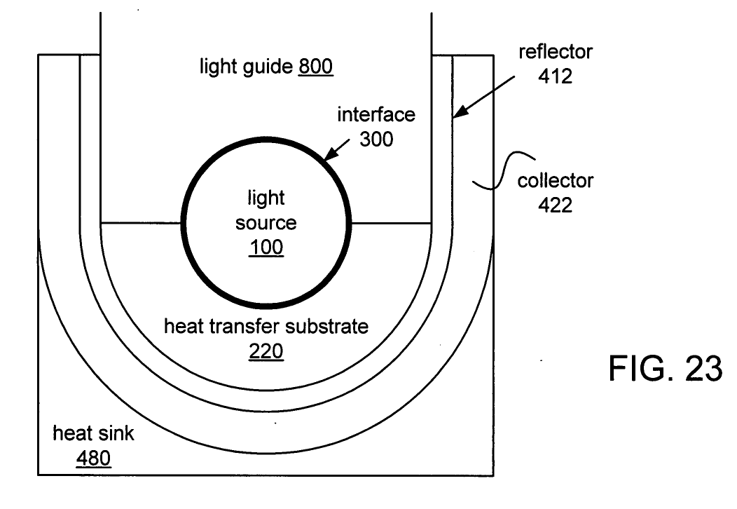

Principles as disclosed herein may be applied to any configuration in which it is desired to increase a degree of thermal coupling of one or more light sources to a heat sink. For example, FIG. 23 shows a cross-section of an edge-lit backlight according to an embodiment.

A generally planar light guide 800 receives light from the light source 100 along an edge. Light guide 800 may be patterned, printed, etched, molded, tapered, and/or faceted to provide a desired distribution of the illumination across the back surface of an imaging panel. For example, such a pattern may be on the order of 10 to 100 microns. Light guide 800 may be made from a material such as glass or PMMA or another suitable resin. In the example of FIG. 23, light source 100 is implemented as a CCFL disposed in a channel along an edge of light guide 800. In other embodiments, light source 100 is a two-legged CCFL, disposed in dual channels along the edge of light guide 800, or is made of another technology, such as LEDs arrayed along an edge of the light guide. The cross-section may include more than one light source 100, arranged side by side and/or one above another.

In the example of FIG. 23, heat transfer substrate 200 is implemented in a semi-cylindrical shape 220. In other embodiments, the cross-section of the substrate has another shape, such as parabolic, and/or the heat transfer substrate extends to embed light source 100 more completely or even entirely.

Reflector 400, implemented as a foil, sheet, layer, or film as described herein, is arranged here to follow the contour of heat transfer substrate 220. In this example, implementation 412 of reflector 410 also extends in cross-section to enclose an end of light guide 800, although other embodiments according to FIG. 23 are contemplated in which the reflector does not extend beyond the top surface of heat transfer substrate 220 on at least one side of light guide 800. It may be desirable for reflector 412 to extend along substantially all of the edge of light guide 800 or at least along a light-generating portion of light source 100.

Collector 420, likewise implemented as described herein, is also arranged here to follow the contour of heat transfer substrate 220. It may be desirable for collector 422 to extend along substantially all of the edge of light guide 800 or at least along a heat-generating portion of light source 100. A heat coupling layer 460 as described herein may also be used.

Heat sink 480 is thermally coupled to collector 422 and may be integrated with collector 422. Heat sink 480 may also be thermally coupled to a back cover of the lighting assembly, which may be generally planar and substantially parallel to light guide 800 and/or the imaging panel. In another example, heat sink 480 is absent and collector 422 is thermally coupled to or integrated with the back cover. In other embodiments, heat sink 480 may be finned, cooled, and/or have any other shape suitable to the particular application.

Further embodiments include assemblies in which an arrangement as shown in FIG. 23 is disposed along more than one edge of a light guide (along opposite edges, for example, or along all four edges).

The foregoing presentation of the described embodiments is provided to enable any person skilled in the art to make or use the present invention. Various modifications to these embodiments are possible, and the generic principles presented herein may be applied to other embodiments as well. In one example, light sources 100 and heat transfer substrate 200 are enclosed in a low-pressure or vacuum chamber, which may reduce heat transfer to an element in front of light sources 100 such as a display panel. In other cases, a chamber enclosing light sources 100 and heat transfer substrate 200 may be cooled by a circulating fluid or gas.

A lighting assembly as described herein may be applied to large panels (such as announcement panels for use in airports, train stations, or other public venues); flat-panel televisions and wall displays; and desktop computer monitors. Such an assembly may also be used in smaller embedded display panels in such applications as vehicle satellite navigation systems, avionic instrumentation display units, automatic teller machines, and consumer dispenser machines (such as fuel pumps and beverage dispensers).

Circuitry of an LCD panel may include an interface card or other circuit configured to convert an incoming video signal in analog or digital (e.g. DVI) format into an LVDS format for processing by the panel driving circuitry. Such circuitry may also include one or more inverters to generate a high-voltage current to drive lamps of the lighting assembly. In some applications, the display panel may also include a CPU. Such integration, which may reduce total system weight and/or size, may be desired in an application such as a vehicular display application. It may also be desired to configure the display CPU as a thin client and possibly to include other functionality such as a USB interface for enhanced connectivity and/or a GPU for enhanced graphics capability. It may be desired to mount such circuitry on the back of the backplate, with electrical insulation, thermal insulation, and/or cooling being provided as appropriate.

A lighting assembly as described herein may also be used in other applications in which a uniform illumination field (especially, a high-intensity field) across a planar or substantially planar surface is desired. Such applications may include automated inspection, identification, and/or monitoring applications, for example, or photographic and photolithographic exposure applications. Thus, the present invention is not intended to be limited to the embodiments shown above but rather is to be accorded the widest scope consistent with the principles and novel features disclosed in any fashion herein.

1. A lighting assembly comprising:
a light source;
a backplate having a reflecting surface arranged to reflect light of the light source; and
a heat transfer substrate disposed between said light source and the reflecting surface and arranged to transfer heat between said light source and said backplate, said heat transfer substrate being substantially transparent to light of said light source and having a thermal conductivity greater than that of air,
said heat transfer substrate including an interface in contact with the light source, said interface being substantially transparent to light of said light source and having a thermal conductivity greater than that of air.

2. A lighting assembly according to claim 1, wherein said light source is a fluorescent lamp.

3. A lighting assembly according to claim 1, wherein said light source is at least partially embedded in a channel of said heat transfer substrate, and wherein said interface is in contact with said light source along the channel.

4. A lighting assembly according to claim 1, wherein said heat transfer substrate is primarily composed of polymethyl methacrylate.

5. A lighting assembly according to claim 1, wherein at least part of a surface of said heat transfer substrate opposite to the reflecting surface has a microstructure diffusive to light reflected by the reflecting surface.

6. A lighting assembly according to claim 1, wherein said interface is a layer of a deformable solid material.

7. A lighting assembly according to claim 1, wherein said interface is a layer at least primarily composed of a silicone material.

8. A lighting assembly according to claim 1, said assembly comprising a fan arranged to cool a side of said backplate opposite the reflecting surface.

9. A lighting assembly according to claim 1, said assembly comprising:
a temperature sensor configured to indicate a temperature of at least one among said light source, said heat transfer substrate, and said backplate; and
a control unit configured to cool said backplate based at least in part on the indication of said temperature sensor.

10. A lighting assembly according to claim 1, said assembly including an imaging panel configured and arranged to selectively transmit light of said light source.

11. A lighting assembly comprising:
a plurality of light sources disposed in a substantially planar arrangement;
a backplate having a reflecting surface arranged to reflect light of the plurality of light sources; and
a heat transfer substrate disposed between said plurality of light sources and the reflecting surface and arranged to transfer heat between said plurality of light sources and said backplate, said heat transfer substrate being generally planar and substantially transparent to light of the plurality of light sources and having a thermal conductivity greater than that of air,
said heat transfer substrate including a plurality of interfaces, the plurality of interfaces being substantially transparent to light of said light sources and having thermal conductivities greater than that of air, each of said plurality of interfaces being in contact with a corresponding one of said plurality of light sources.

12. A lighting assembly according to claim 11, wherein said plurality of light sources comprises a plurality of elongated fluorescent lamps, and wherein said lighting assembly includes a circuit configured to drive each of the plurality of lamps with an alternating current that is substantially out-of-phase with an adjacent one of the plurality of lamps.

13. A lighting assembly according to claim 11, wherein each of said plurality of light sources is an elongated fluorescent lamp having two legs, each leg having an electrical terminal configured to receive a driving current of the lamp, and the electrical terminals of the two legs being disposed at the same end of the length of the lamp, and
wherein a region of said heat transfer substrate that is (A) between the two legs of one of said lamps and (B) nearer to the end of the length of the lamp at which the terminals are disposed than to the other end of the length of the lamp includes at least one slot.

14. A lighting assembly according to claim 11, said assembly comprising a plurality of luminance sensors, each configured and arranged to indicate a luminance of a corresponding one of said plurality of light sources.

15. A lighting assembly according to claim 11, said assembly including a color liquid crystal display panel configured and arranged to selectively transmit light of said plurality of light sources.

16. A method of controlling a temperature of a lighting assembly, the lighting assembly comprising:
a light source;
a backplate having a reflecting surface facing the light source; and
a heat transfer substrate disposed between the light source and the reflecting surface and arranged to transfer heat between the light source and the backplate, the heat transfer substrate being substantially transparent to light of the light source and having a thermal conductivity greater than that of air,
the heat transfer substrate including an interface in contact with the light source, the interface being substantially transparent to light of the light source and having a thermal conductivity greater than that of air,
wherein said method comprises:
receiving an indication of at least one of (A) a luminance of the light source and (B) a temperature of at least one among the light source, the backplate, and the heat transfer substrate; and
controlling at least one among a cooling device and a heating device to change a temperature of the backplate, wherein said controlling is based at least in part on the received indication.

17. A method of controlling a temperature according to claim 16, wherein said controlling comprises controlling a speed of at least one fan.

18. A method of controlling a temperature according to claim 16, wherein said controlling comprises activating a heater.

19. A method of controlling a temperature according to claim 16, wherein the lighting assembly includes:
a plurality of light sources disposed in a substantially planar arrangement; and
a plurality of luminance sensors, each configured and arranged to indicate a luminance of a corresponding one of the plurality of light sources, and
wherein said method includes, for each of the plurality of luminance sensors, controlling a driving current of the corresponding light source according to the indicated luminance.

20. A data storage medium having machine-readable instructions describing a method of controlling a temperature according to claim 16.
